(19) United States
(12) Patent Application Publication
(10) Pub. No.: US 2008/0036984 A1
(43) Pub. Date: Feb. 14, 2008

(54) Method and apparatus for angular-resolved spectroscopic lithography characterization

(75) Inventors: Everhardus Cornelis Mos, Best (NL); Arie Jeffrey Den Boef, Waalre (NL); Maurits Van Der Schaar, Veldhoven (NL); Stefan Carolus Jacobus Antonius Keij, Breda (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/500,494

(22) Filed: Aug. 8, 2006

(51) Int. Cl. G03B 27/42

(52) U.S. Cl. 355/53; 355/72; 355/69

(57) ABSTRACT

A combined alignment and overlay target to be applied to a substrate to enable measurement of the alignment of the substrate with respect to its surroundings, and measurement of the relative alignment of a series of layers on the substrate, is disclosed. In an embodiment, the target comprises an array of structures substantially equidistant apart except for a portion of the structures that are offset by a specific amount in a first direction, and a second portion of the structures that are offset by the same amount in the opposite direction. This target on the substrate may be used to measure its alignment and the same target applied to a second layer, superposed on a first layer, may be used to measure overlay.

### FIELD

The present invention relates to a method of inspection usable, for example, in the manufacture of devices by a lithographic technique and to a method of manufacturing devices using a lithographic technique.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It is important to ensure that a substrate is aligned with the pattern that is to be transferred onto the substrate, particularly in one or more exposures subsequent to the first exposure of the substrate. This is because a pattern needs to be exposed several times in the same place on the substrate in order to build up the pattern to the correct depth (e.g. for a semiconductor chip or integrated circuit, etc.). There are at least two steps in the processing of a substrate layer during which alignment is measured. The first is the alignment of the substrate on a substrate table with respect to an exposure apparatus so that the pattern is exposed in the right area of the substrate and with the right orientation. The second is after the pattern has been exposed, to measure the alignment of the two layers, or their overlay. If the patterns in successive layers match up exactly, there is no overlay error.

Both alignment measurement and overlay measurement require targets or marks to be placed on the substrate from which measurements can be made. The targets are generally provided in a part of the substrate known as a scribe lane. The scribe lane is a part of the substrate that will not have a pattern exposed in it and is, for example, most likely the position in which the substrate will be sawn in order to separate the different ICs, etc., that will be exposed on the same substrate.

An alignment target should be symmetrical but it may otherwise take any calibrated, predetermined form as long as the reflected radiation has a recognizable and measurable pattern. One way of measuring the alignment of a substrate on a substrate table with respect to the exposure apparatus is to have a sensor in a fixed position on the substrate table or in the exposure apparatus (or any other part of the lithographic apparatus or other part of a lithographic cell relative to which the substrate must be aligned). A reflective alignment target is already exposed on the substrate before the first pattern exposure. An alignment beam is reflected from the alignment target on the substrate and onto the sensor. The alignment target on the substrate is aligned when the reflected alignment beam coincides with a reference point within the sensor. This reference point can, for example, be a reference grating. The exposure apparatus may then be adjusted to allow for the misalignment of the substrate.

Overlay measurements also use a target, but in consecutive layers of resist (for example) on a substrate. A (usually grating-shaped) target is imprinted on two consecutive layers of a substrate. Specifically, each time a layer of resist (or radiation-sensitive material) is applied, an overlay target is exposed, etched or otherwise created on the layer of resist and this overlay target is compared with the target on the substrate surface (or on the layer below it if the previous layer of resist has not been removed at that point). The overlay target will often take the shape of a grating. This is because the overlap of one grating on another is detectable using an overlay radiation beam by measuring the diffraction pattern of the beam as it is reflected from the surface of the superposed overlay targets. The overlay beam is therefore reflected off the surface of the overlay target, and an image is created, on, for example, a camera, of the reflected beam. By comparing the properties of the reflected beam, one or more properties of the substrate can be determined. This can be done, for example, by comparing the reflected beam with data stored in a library of known measurements associated with known substrate layer overlays.

The alignment of the substrate should be measured before exposure to ensure that the next exposure layer will be aligned with one or more previous layers. This is different from the measurement of overlay because alignment measurement is carried out before exposure, whereas overlay measurement is carried out afterwards. The results of alignment measurement will be returned to either the exposure apparatus so that the exposure is corrected in advance of the exposure of a specific layer, or to the substrate table that supports the substrate so that the substrate may be moved in line with the exposure system. On the other hand, the result of an overlay measurement can be fed back to the lithographic apparatus so that trends or shifts in overlay errors may be monitored and corrected for both in the short and long terms.

Both the alignment targets and the overlay targets may be positioned in the scribe lane of the substrate so that they do not get in the way of the exposure pattern. An alignment target is arranged to show the alignment of the substrate with respect to its surroundings and to the exposure apparatus, whereas the overlay target is in two subsequent layers and shows how the two layers are in line with respect to each other. Having large numbers of targets (i.e. both alignment and overlay targets) in scribe lanes takes up scribe lane space, which a user may prefer to use for test patterns and the like.

### SUMMARY

It is desirable, for example, to provide a system to measure both alignment and overlay that takes up less scribe lane space.

According to an aspect of the invention, there is provided a substrate comprising a combined alignment and overlay target comprising an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

According to an aspect of the invention, there is provided a substrate comprising a combined alignment and overlay target comprising an array of structures, a first portion of the structures having an offset relative to a hypothetical periodic array of structures, the offset being in a first direction, and a second portion of the structures having a different offset relative to the same hypothetical periodic array of structures, the offsets of the first and second portions being in the same direction and substantially in the plane of the substrate.

According to another aspect of the invention, there is provided a substrate comprising a combined alignment and overlay target, wherein the target comprises two superposed layers, each layer containing a target comprising an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

According to another aspect of the invention, there is provided an inspection apparatus configured to measure a property of a substrate, comprising:

an exposure tool configured to expose a combined alignment and overlay target on the substrate;

a radiation source configured to radiate the combined alignment and overlay target on the substrate with radiation; and

a detector configured to detect the radiation reflected from the combined alignment and overlay target,

wherein the combined alignment and overlay target comprises an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

According to yet another aspect of the invention, there is provided an inspection method comprising:

applying a first array of structures on a substrate, a first portion of the structures having a first offset relative to a hypothetical periodic array of structures, the first offset being in a first direction, and a second portion of the structures having a second offset relative to the same hypothetical periodic array of structures, the second offset being in the opposite direction relative to the first offset, both first and second offsets being substantially in the plane of the substrate;

radiating the first array of structures with an alignment radiation beam;

comparing the alignment radiation beam reflected from the first array of structures with an alignment radiation beam reflected from a model target positioned other than on the substrate;

determining the alignment of the substrate with respect to the model target;

applying, to a resist layer on the substrate, a second array of structures similar to the first array of structures such that the first array of structures on the substrate has the second array of structures superposed onto it;

radiating the superposed arrays of structures with an overlay radiation beam;

measuring the diffraction spectra of radiation diffracted from the superposed arrays of structures; and

determining intensity asymmetry of the diffracted radiation to determine the extent of overlay of the superposed arrays of structures.

According to another aspect of the invention, there is provided a lithographic apparatus configured to measure a property of a substrate, comprising:

an exposure tool configured to expose a combined alignment and overlay target on the substrate;

a radiation source configured to supply a radiation beam to illuminate the combined alignment and overlay target; and

a detector configured to detect the radiation beam reflected from the combined alignment and overlay target,

wherein the combined alignment and overlay target comprises an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

According to yet a further aspect of the invention, there is provided a lithographic cell configured to measure a property of a substrate, comprising:

an exposure tool for exposing a combined alignment and overlay target on the substrate;

a radiation source for supplying a radiation beam to radiate the combined alignment and overlay target; and

a detector for detecting the radiation beam reflected from the combined alignment and overlay target,

wherein the combined alignment and overlay target comprises an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which

FIG. 1a depicts a lithographic apparatus;

FIG. 1b depicts a lithographic cell or cluster;

FIG. 2 depicts a scatterometer according to one embodiment of the invention;

FIG. 3 depicts a scatterometer according to a second embodiment of the invention;

FIG. 4 depicts a combined alignment and overlay target; and

FIG. 5 depicts an overlay target based on the alignment target of FIG. 4.

### DETAILED DESCRIPTION

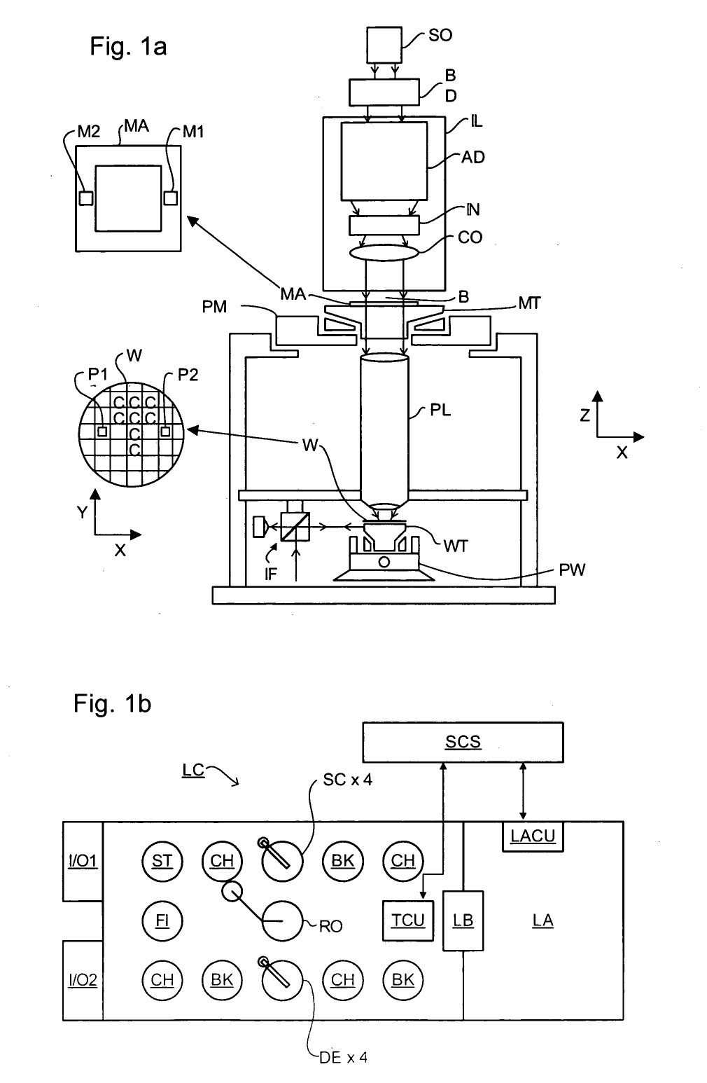

FIG. 1a schematically depicts a lithographic apparatus. The apparatus comprises:

an illumination system (illuminator) IL configured to condition a radiation beam B (e.g. UV radiation or EUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1a, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1a) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device targets M1, M2 and substrate targets P1, P2. Although the substrate targets as illustrated occupy dedicated target portions, they may be located in spaces between target portions (these are known as scribe lane targets). Similarly, in situations in which more than one die is provided on the patterning device MA, the patterning device targets may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 1b, the lithographic apparatus LA forms part of a lithographic cell LC, also sometimes referred to as a lithocell or cluster, which also includes devices to perform one or more pre- and post-exposure processes on a substrate. Conventionally these include one or more spin coaters SC to deposit resist layers, one or more developers DE to develop exposed resist, one or more chill plates CH and one or more bake plates BK. A substrate handler, or robot, RO picks up substrates from input/output ports I/O1, I/O2, moves them between the different process devices and delivers them to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure one or more properties such as overlay error between subsequent layers, line thicknesses, critical dimensions (CD), etc. If errors are detected, an adjustment may be made to the exposure of one or more subsequent substrates, especially if the inspection can be done soon and fast enough that one or more other substrates of the same batch are still to be exposed. Also, one or more already exposed substrates may be stripped and reworked—to improve yield—or discarded—thereby avoiding performing exposure on one or more substrates known to be faulty. In a case where only one or more target portions of a substrate are faulty, further exposures may be performed only on those target portions which are good.

An inspection apparatus is used to determine the one or more properties of the substrate, and in particular, how the one or more properties of different substrates or different layers of the same substrate vary from layer to layer. The inspection apparatus may be integrated into the lithographic apparatus LA or the lithocell LC or may be a stand-alone device. To enable rapid measurement, it is desirable that the inspection apparatus measure one or more properties in the exposed resist layer immediately after the exposure. However, the latent image in the resist has a very low contrast—there is only a very small difference in refractive index between the parts of the resist that have been exposed to radiation and those which have not—and not all inspection apparatus have sufficient sensitivity to make useful measurements of the latent image. Therefore measurement may be taken after the post-exposure bake step (PEB), which is customarily the first step carried out on an exposed substrate and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibility for rework of a faulty substrate but may still provide useful information.

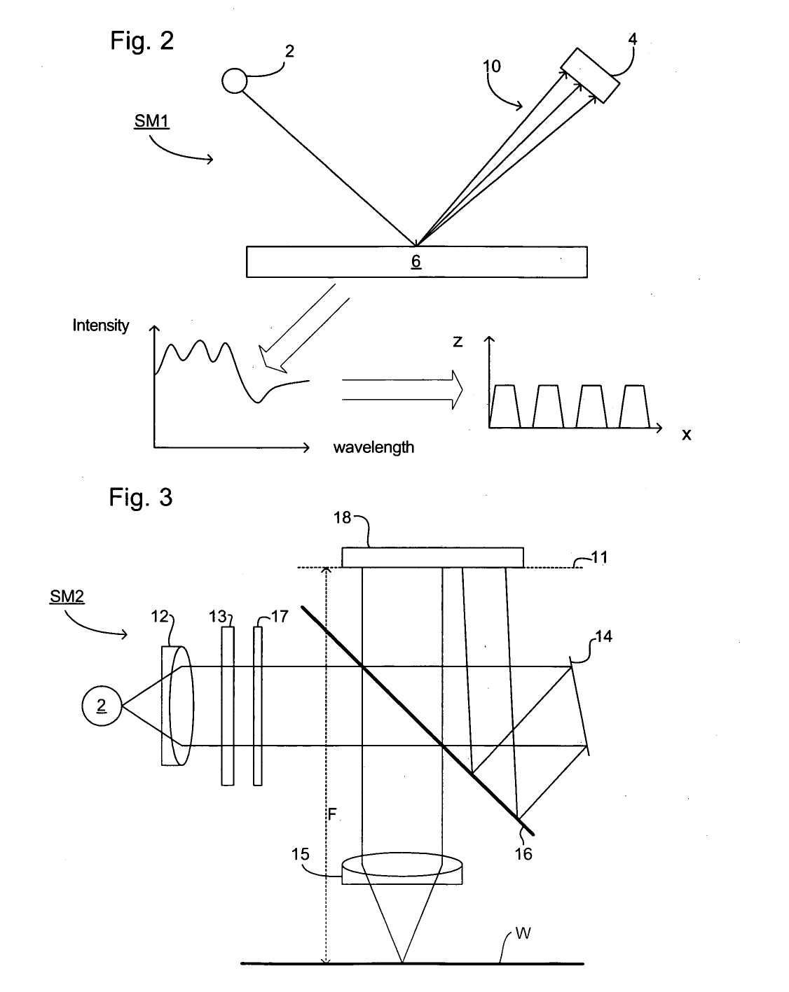

FIG. 2 depicts a scatterometer that may be used in an embodiment of the present invention. It comprises a broadband (white light) radiation projector 2, which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed, e.g. by Rigorous Coupled Wave Analysis and non-linear regression or by comparison with a library of simulated spectra as shown at the bottom of FIG. 2. In general for the reconstruction, the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer. The radiation source 2 may be part of the scatterometer or may simply be conduit of radiation from an outside radiation generator.

Another scatterometer that may be used with an embodiment of the present invention is shown in FIG. 3. In this device, the radiation emitted by radiation source 2 is focused using lens system 12 through interference filter 13 and polarizer 17, reflected by partially reflective surface 16 and is focused onto substrate W via a microscope objective lens 15, which has a high numerical aperture (NA), in an embodiment at least 0.9 or at least 0.95. An immersion scatterometer may even have a lens with a numerical aperture over 1. The reflected radiation then transmits through partially reflective surface 16 into a detector 18 in order to have the scatter spectrum detected. The detector may be located in the back-projected pupil plane 11, which is at the focal length of the lens system 15, however the pupil plane may instead be re-imaged with auxiliary optics (not shown) onto the detector. The pupil plane is the plane in which the radial position of radiation defines the angle of incidence and the angular position defines the azimuth angle of the radiation. In an embodiment, the detector is a two-dimensional detector so that a two-dimensional angular scatter spectrum of the substrate target can be measured. The detector 18 may be, for example, an array of CCD or CMOS sensors, and may have an integration time of, for example, 40 milliseconds per frame. The radiation source 2 may be part of the scatterometer or may simply be conduit of radiation from an outside radiation generator.

A reference beam is often used for example to measure the intensity of the incident radiation. To do this, when the radiation beam is incident on the partially reflective surface 16 part of it is transmitted through the partially reflective surface as a reference beam towards a reference mirror 14. The reference beam is then projected onto a different part of the same detector 18.

A set of interference filters 13 is available to select a wavelength of interest in the range of, say, 405-790 nm or even lower, such as 200-300 nm. The interference filter may be tunable rather than comprising a set of different filters. A grating could be used instead of one or more interference filters.

The detector 18 may measure the intensity of scattered radiation at a single wavelength (or narrow wavelength range), the intensity separately at multiple wavelengths or the intensity integrated over a wavelength range. Furthermore, the detector may separately measure the intensity of transverse magnetic- and transverse electric-polarized radiation and/or the phase difference between the transverse magnetic- and transverse electric-polarized radiation.

Using a broadband radiation source (i.e. one with a wide range of radiation frequencies or wavelengths—and therefore of colors) is possible, which gives a large etendue, to allow mixing of multiple wavelengths. The plurality of wavelengths in the broadband preferably each has a bandwidth of *8 and a spacing of at least 2*8 (i.e. twice the wavelength). Several “sources” of radiation can be different portions of an extended radiation source which have been split using fiber bundles. In this way, angle resolved scatter spectra can be measured at multiple wavelengths in parallel. A 3-D spectrum (wavelength and two different angles) may be measured, which contains more information than a 2-D spectrum. This allows more information to be measured which increases metrology process robustness. This is described in more detail in European patent application publication EP1,628,164A.

The target on substrate W may be a grating that is printed such that, after development, the bars are formed of solid resist lines. The bars may alternatively be etched into the substrate. This pattern is sensitive to chromatic aberrations in the lithographic projection apparatus, particularly the projection system PL, and illumination symmetry and the presence of such aberrations will manifest themselves in a variation in the printed grating. Accordingly, the scatterometry data of the printed grating is used to reconstruct the grating. The parameters of the grating, such as line widths and shapes, may be input to the reconstruction process from knowledge of the printing step and/or other scatterometry processes.

As discussed above, it is important that each time a substrate undergoes an exposure process, the substrate is in the same orientation with respect to the exposure device as for one resist layer such that the pattern at every exposure is desirably perfectly overlapping with a pattern in one or more previous layers. Errors in alignment cause overlay errors in the exposed pattern on the substrate, causing the substrate to be less useful or even useless enough to have to be stripped and re-exposed. The relative alignment of the substrate between exposures is therefore detected (by measuring the overlay of a subsequent layer on the substrate) and any errors calculated are compensated for by the exposure apparatus or by one or more post-exposure processes, where possible.

An inspection apparatus separate from the lithographic apparatus (the latter containing the exposure apparatus) is used to determine one or more properties of the substrate, and in particular, how the one or more properties of the substrate varies from layer to layer and from the substrate to another substrate. The inspection apparatus is thereby also used to determine how one or more properties of a substrate varies from lithography machine to lithography machine and is therefore useful in determining how each lithography machine should be calibrated in order to produce a consistent product even with a series of apparatuses. This is measured using overlay metrology.

To measure overlay, the diffraction spectrum of superposed gratings in the scribe lane of a substrate has been used to determine the misalignment of the substrate. The way the overlay target in the form of a grating works is that when an overlay beam is directed onto a grating that is either in line with the grating below it or not superposed on another grating at all, a specific diffraction spectrum is created in the overlay beam being reflected off the grating. However, misalignment of the gratings causes a slight intensity asymmetry between the various diffraction orders N and −N in the diffraction spectrum, which can be seen over various diffraction orders. The larger the misalignment, the larger the intensity asymmetry in the diffraction spectrum.

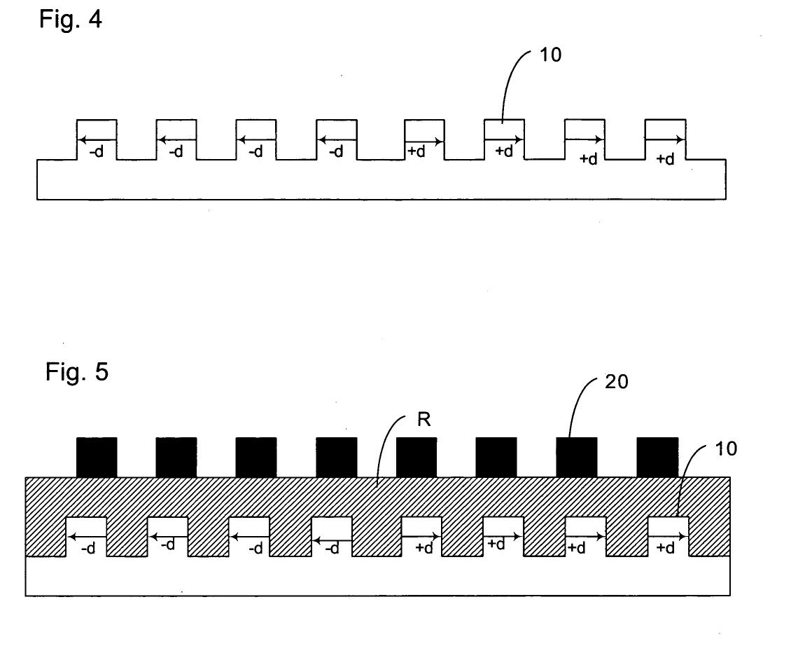

A solution to saving scribe lane space while still enabling the measurement of alignment of the substrate and of the overlay is to have a target that can be used for both measurements. A target, which may be used for both alignment and overlay measurement, is therefore shown in FIGS. 4 and 5.

FIG. 4 shows a basic alignment target according to an embodiment of the present invention. Of course, an embodiment of the invention applies equally to a more complex alignment target that may be, for example, a sub-segmented or mixed first and higher diffraction order target known as an enhanced target. An alignment target desirably comprises a series of structures 10 that are substantially equidistant apart and create a periodic array (e.g., a one-dimensional array or a two-dimensional array). The alignment target shown in FIG. 4 is similar to such an alignment target, except that the four structures (e.g., rectangular structures) on the left of the diagram have a small shift of −d nm and the four structures on the right side of the figure have a shift of +d nm with respect to the hypothetical periodic array of structures, i.e. the structures of the right side of the array have the same shift as the structures on the left hand side of FIG. 4, but in the opposite direction. The shift in opposite directions is not limited to being the same offset d. Each set of structures could have a shift in +d and −e, for instance.

FIG. 5 shows the overlapping of a second alignment target that does not have the small shift. The measurement of the overlay error between these two layers will be described later. However, the two layers of alignment targets can of course be swapped so that the bottom target does not have the small shift +d or −d and the top layer does have the shift.

The separation of the structures (or the distance between the structures) can be chosen so that it is measurable with an existing alignment system. For example, the separation can be chosen so that the alignment may be measured using a known alignment measuring system.

An alignment beam with a pattern in it that is the same pattern or at least the same frequency as the alignment target can be compared with this alignment target as discussed above or as shown in FIG. 4. An alignment system determines the position of the alignment target with respect to a fixed reference point. The fixed reference point may be a reference grating of a similar shape or at least frequency to the alignment target, or the fixed reference point may be a self-referencing interferometer.

FIG. 5 shows a second layer of structures 20 that is superposed on to the basic alignment target structures 10. The second layer 20 is most commonly imprinted, etched or exposed on a resist (or radiation-sensitive) layer R. An overlay measurement beam is reflected from the surface of the second layer 20 of structures. If the second layer is in line with the first layer, only a single series of structures will be “visible” in the diffraction pattern of the reflected beam. However, as in standard overlay measurement, if there is a misalignment of the two layers, the deflection spectrum of the overlay measurement beam will be affected by the lower structures 10 (i.e. the alignment target) as well as the upper layer of structures 20. In FIG. 5, the second layer has no bias. However, an embodiment has a first layer 10 with no bias and a second layer 20 with the bias +d and −d, for instance.

The value of d is advantageously small.

When the small shift of + or −d is used in the first target, namely the alignment target, alignment measurement systems will expect d to be 0, as they will not have the shift in the alignment beam. However, if d is sufficiently small (e.g. of the order of 10 to 50 nm and in an embodiment, about 20 nm), the alignment measurement system will not be able to detect the shift and an error will not be detected. Generally, the shift will be averaged out during the alignment measurement.

For the measurement of overlay, on the other hand, the overlay of two layers, each containing an overlay measurement target, is obtained by measuring the asymmetry A in the intensity between diffraction order N and diffraction order −N. For a small overlay, the asymmetry is linearly proportional to the overlay:

A=K×OV (1)

where K is an unknown proportionality factor.

The overlay can be determined from the measured asymmetry by using two overlapping gratings with an opposite bias d. The equations would be amended, for example, to take into account different biases +d and −e, for instance, or different biases in the same direction, +d and +e, for instance. Two asymmetries are thereby measured:

A1=K(OV+d)

A2=K(OV−d) (2)

This yields two equations with two unknowns (OV and K) that can therefore be solved. However, d must be small so that the asymmetry varies linearly for values of |OV+d| that are small compared to the pitch of the grating.

The TIS (tool induced shift) is determined by measuring the same grating a second time, rotated 180°. The overlay will also be rotated with the grating but the TIS will have the same magnitude and sign and can then be determined and removed as an error. The measured asymmetry A contains an offset term A_tool that is introduced by sensor imperfections. The measured asymmetry is therefore:

A=K×OV+A_tool (3)

By rotating the substrate, the overlay changes sign and A_tool remains constant. The tool-induced shift in asymmetry can thereby be determined using the two measurements of the grating.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

I/We claim:

1. A substrate comprising a combined alignment and overlay target comprising an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

2. The substrate of claim 1, wherein the target comprises a layer of structures superposed onto the array of structures, the layer of structures having similar offsets to the array of structures.

3. The substrate of claim 1, wherein approximately half of the structures have the first offset in the first direction and the rest of the structures have the second offset in the opposite direction.

4. The substrate of claim 1, wherein the magnitude of the first offset is substantially the same as the second offset.

5. The substrate of claim 1, wherein the offset is between 10 nm to 50 nm.

6. The substrate of claim 5, wherein the offset is about 20 nm.

7. The substrate of claim 1, wherein the target comprises a grating and the structures are bars of the grating.

8. The substrate of claim 1, wherein the target comprises a one-dimensional array of rectangular structures.

9. The substrate of claim 1, wherein the target comprises a two-dimensional array of rectangular structures.

10. A substrate comprising a combined alignment and overlay target comprising an array of structures, a first portion of the structures having an offset relative to a hypothetical periodic array of structures, the offset being in a first direction, and a second portion of the structures having a different offset relative to the same hypothetical periodic array of structures, the offsets of the first and second portions being in the same direction and substantially in the plane of the substrate.

11. The substrate of claim 10, wherein the target comprises a layer of structures superposed onto the array of structures, the layer of structures having similar offsets to the array of structures.

12. The substrate of claim 10, wherein the offset is between 10 nm to 50 nm.

13. A substrate comprising a combined alignment and overlay target, wherein the target comprises two superposed layers, each layer containing a target comprising an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

14. The substrate of claim 13, wherein approximately half of the structures have the first offset in the first direction and the rest of the structures have the second offset in the opposite direction.

15. The substrate of claim 13, wherein the magnitude of the first offset is substantially the same as the second offset.

16. The substrate of claim 13, wherein the offset is between 10 nm to 50 nm.

17. An inspection apparatus configured to measure a property of a substrate, comprising:
an exposure tool configured to expose a combined alignment and overlay target on the substrate;
a radiation source configured to radiate the combined alignment and overlay target on the substrate with radiation; and
a detector configured to detect the radiation reflected from the combined alignment and overlay target,
wherein the combined alignment and overlay target comprises an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

18. An inspection method comprising:
applying a first array of structures on a substrate, a first portion of the structures having a first offset relative to a hypothetical periodic array of structures, the first offset being in a first direction, and a second portion of the structures having a second offset relative to the same hypothetical periodic array of structures, the second offset being in the opposite direction relative to the first offset, both first and second offsets being substantially in the plane of the substrate;
radiating the first array of structures with an alignment radiation beam;
comparing the alignment radiation beam reflected from the first array of structures with an alignment radiation beam reflected from a model target positioned other than on the substrate;
determining the alignment of the substrate with respect to the model target;
applying, to a resist layer on the substrate, a second array of structures similar to the first array of structures such that the first array of structures on the substrate has the second array of structures superposed onto it:
radiating the superposed arrays of structures with an overlay radiation beam:
measuring the diffraction spectra of radiation diffracted from the superposed arrays of structures; and
determining intensity asymmetry of the diffracted radiation to determine the extent of overlay of the superposed arrays of structures.

19. A lithographic apparatus configured to measure a property of a substrate, comprising:
an exposure tool configured to expose a combined alignment and overlay target on the substrate;
a radiation source configured to supply a radiation beam to illuminate the combined alignment and overlay target; and
a detector configured to detect the radiation beam reflected from the combined alignment and overlay target,
wherein the combined alignment and overlay target comprises an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.

20. A lithographic cell configured to measure a property of a substrate, comprising:
an exposure tool for exposing a combined alignment and overlay target on the substrate;
a radiation source for supplying a radiation beam to radiate the combined alignment and overlay target; and
a detector for detecting the radiation beam reflected from the combined alignment and overlay target,
wherein the combined alignment and overlay target comprises an array of structures, a first portion of the structures having a first offset relative to a hypothetical periodic array of structures, the first offset being in a first direction, and a second portion of the structures having a second offset relative to the same hypothetical periodic array of structures, the second offset being in the opposite direction from that of the first offset, both the first and second offsets being substantially in the plane of the substrate.
